(19) United States
(12) Patent Application Publication
(10) Pub. No.: US 2014/0164100 A1
(43) Pub. Date: Jun. 12, 2014

(54) SYSTEM AND METHOD FOR PROVIDING RECOMMENDATIONS

(71) Applicant: Codemasters International, LLC, Boca Raton, FL (US)

(72) Inventors: Alexander Koval, Boca Raton, FL (US); Alexander Dekhtyar, San Luis Obispo, CA (US); Maxim Olegovich Rubtsov, Saransk (RU)

(73) Assignee: Codemasters International, LLC, Boca Raton, FL (US)

(21) Appl. No.: 14/105,112

(22) Filed: Dec. 12, 2013

Related U.S. Application Data
(60) Provisional application No. 61/736,471, filed on Dec. 12, 2012.

(51) Int. Cl. G06Q 30/02

(52) U.S. Cl. CPC G06Q 30/0244; G06Q 30/0246
USPC 705/14.43; 705/14.45

(57) ABSTRACT

A computerized recommender system and an associated computer-implemented method, which accumulate and analyze the information about various marketing actions for promoting brands as well as information about the subsequent brand performance within media channels. The channels include, but are not limited to web, blogs, social networks, search engines, contextual ad networks, email campaigns, and other promotional activities. Additional media channels can be added into the recommender system. The described recommender system enables the marketers to obtain custom advice for a given brand as to what should be the next most effective marketing actions to promote the brand.

### CROSS-REFERENCE TO RELATED PATENT APPLICATION

The present regular U.S. patent application relies upon and claims the benefit of priority from U.S. provisional patent application No. 61/736,471 filed on Dec. 12, 2012, the entire disclosure of which is incorporated by reference herein.

### BACKGROUND OF THE INVENTION

1. Field of the Invention

The described embodiments relate in general to methods and systems for providing recommendations to Brand Marketers who are promoting Brands and, more particularly, to recommending Marketing Actions, which would increase number of customers of the Brand brought through available Media Channels.

2. Description of the Related Art

Promoting a Brand includes executing Marketing Actions across Media Channels. In accordance with conventional technology, it is a costly trial and error process as human work is required to identify and execute series of Marketing Actions. Therefore, there is a need for systems and methods that would automate this process and produce reliable recommendations to increase the number of Customers of the Brand through the Media Channels.

Certain terms of art will be are used in the present patent specification in accordance with the respective meanings specified in the below table.

| Term | Explanation |
|---|---|
| Brand | Brand is the object of promotion |
| Brand Marketer | Person who promotes the Brand |
| Brand Taxonomy | Industry Classification of the Brand |
| Potential | Person interested in purchasing from the Brand |
| Customer | |
| Marketing Action | Action taken by Brand Marketer to promote the Brand |
| Media Channel, | Specific way to represent the Brand and communicate |
| Brand Media | with the audience. |
| Channel | |
| Brand Feature | Property of the Brand |
| Brand Metrics | Set of measured values related to the activity of |
| | Potential Customers of the Brand |
| Brand State | Set of measured values related to the Brand |
| | representation in Media Channels |
| Recommendation | Changes in Brand Metrics related to Potential |
| Effect | Customers caused by Marketing Action. |
| API | Application Programming Interface |
| Brand Similarity | Degree to which two Brands are similar |
| Brand Model | Attributes of the Brand |
| Parameters | |
| Target Audience | People or organizations targeted by Marketing Activity |
| | of the Brand Marketer |

### SUMMARY OF THE INVENTION

One or more of the described embodiments are generally directed to computerized methods and systems that automatically recommend marketing activity for promoting a given Brand across marketing channels.

In accordance with one aspect of the embodiments described herein, a recommender system is provided. In one or more embodiments, the recommender system is a computerized system, which accumulates and analyzes the information about Marketing Actions for promoting Brands as well as information about the subsequent Brand performance within Media Channels. The Channels include, but are not limited to Web, Blogs, Social Networks, Search Engines, Contextual Ad Networks, Email Campaigns, and other promotional activities. More Media Channels can be added into the recommender system. This recommender system enables the Marketers to obtain custom advice for a given Brand as to what should be the next most effective Marketing Actions to promote the Brand.

The described embodiments provide methods and algorithms of the recommender system for suggesting most effective Marketing Actions for promoting the Brand. The recommender system contains an extendable set of recommendations (possible Marketing Actions) within Media Channels. The recommender system predicts the effect of each Marketing Action upon the Target Audience of the Brand through applying machine learning algorithm. The training sets are obtained through measuring the Marketing Actions and the changes in the Brand Metrics, caused by the Marketing Actions. Marketing Actions are determined through analyzing the difference in subsequent snapshots of the Brand State. The Effect of the Marketing Action is determined through measuring Brand Metrics after the Marketing Action. The effect of the Marketing Action is predicted by fitting the collected data into the developed model and using Collaborative Filtering.

In accordance with another aspect of the embodiments described herein, methods and algorithms are provided to determine the applicability of marketing knowledge accumulated by one Brand to another Brand. The applicability of marketing knowledge is determined through calculating the Brand Similarity as well as comparison of Brand Model Parameters between two Brands.

In accordance with yet another aspect of the embodiments described herein, there is provided a computerized system for providing recommendations in connection with a brand, the computerized system comprising at least one processing unit, a data storage unit and a memory unit, the at least one processing unit executing instructions including: a user event collector module for collecting user events information associated with potential customers in connection with the brand in each of a plurality of media channels and storing the collected user events information in the data storage unit; a brand metrics crawler for measuring metrics of the brand in each of the plurality of media channels and storing the measured brand metrics in the data storage unit; a brand state crawler for collecting information on a marketing activity in connection with the brand in each of the plurality of media channels and storing the collected marketing activity information in the data storage unit; and a recommender module for analyzing the collected user events information, the measured brand metrics and the collected marketing activity information to obtain a brand feedback information, for storing the brand feedback information in the data storage unit and for providing a plurality of recommendations based on the brand feedback information.

In one or more embodiments, the plurality of channels comprise at least one channel selected from a group of web, blogs, social networks, search engines, contextual ad networks, and email campaigns.

In one or more embodiments, the data storage unit further stores a user events aggregation module for aggregating the collected user events information and storing the aggregated user events information in a database system.

In one or more embodiments, the data storage unit further stores a measured brand metrics aggregation module for aggregating the measured brand metrics and storing the aggregated measured brand metrics in a database system.

In one or more embodiments, the data storage unit further stores a marketing activity information aggregation module for aggregating the collected marketing activity information and storing the aggregated marketing activity information in a database system.

In one or more embodiments, the at least one processing unit further executes a configuration module for receiving information on the plurality of media channels.

In one or more embodiments, the at least one processing unit further executes a user interface module for providing the plurality of recommendations to a user.

In one or more embodiments, the plurality of recommendations comprise an ordered list of marketing actions associated with the plurality of media channels.

In one or more embodiments, the recommender module is configured to sort the ordered list of marketing actions based on a predicted marketing effect.

In one or more embodiments, the recommender module is configured to calculate a similarity between two brands and to obtain brand similarity information.

In one or more embodiments, the recommender module is configured to accumulate marketing experience for the brand through recording subsequent snapshots of brand model parameters and calculated effect of each change of brand content associated with the brand.

In one or more embodiments, the recommender module is configured to apply the marketing experience accumulated for a first brand to a second brand based on the brand model parameters, the brand similarity information, and the calculated change effect.

In one or more embodiments, the recommender module is configured to predict an effect of a change of a brand content based on the accumulated marketing experience and the brand similarity information.

In accordance with yet another aspect of the embodiments described herein, there is provided a computer-implemented method for providing recommendations in connection with a brand, the computer-implemented method being performed in connection with a computerized system comprising at least one processing unit, a data storage unit and a memory unit, the method involving: collecting user events information associated with potential customers in connection with the brand in each of a plurality of media channels and storing the collected user events information in the data storage unit; measuring metrics of the brand in each of the plurality of media channels and storing the measured brand metrics in the data storage unit; collecting information on a marketing activity in connection with the brand in each of the plurality of media channels and storing the collected marketing activity information in the data storage unit; analyzing the collected user events information, the measured brand metrics and the collected marketing activity information to obtain a brand feedback information; storing the brand feedback information in the data storage unit; and providing a plurality of recommendations based on the brand feedback information.

In one or more embodiments, the plurality of channels comprise at least one channel selected from a group of web, blogs, social networks, search engines, contextual ad networks, and email campaigns.

In one or more embodiments, the data storage unit further stores a user events aggregation module for aggregating the collected user events information and storing the aggregated user events information in a database system.

In one or more embodiments, the data storage unit further stores a measured brand metrics aggregation module for aggregating the measured brand metrics and storing the aggregated measured brand metrics in a database system.

In one or more embodiments, the data storage unit further stores a marketing activity information aggregation module for aggregating the collected marketing activity information and storing the aggregated marketing activity information in a database system.

In one or more embodiments, the method further involves receiving information on the plurality of media channels.

In one or more embodiments, the plurality of recommendations comprise an ordered list of marketing actions associated with the plurality of media channels.

In one or more embodiments, the method further involves sorting the ordered list of marketing actions based on a predicted marketing effect.

In one or more embodiments, the method further involves calculating a similarity between two brands and to obtain brand similarity information.

In one or more embodiments, the method further involves accumulating marketing experience for the brand through recording subsequent snapshots of brand model parameters and calculated effect of each change of brand content associated with the brand.

In one or more embodiments, the method further involves applying the marketing experience accumulated for a first brand to a second brand based on the brand model parameters, the brand similarity information, and the calculated change effect.

In one or more embodiments, the method further involves predicting an effect of a change of a brand content based on the accumulated marketing experience and the brand similarity information.

In accordance with a further aspect of the embodiments described herein, there is provided a non-transitory computer-readable medium embodying a set of computer-executable instructions, which, when executed in connection with a computerized system comprising at least one processing unit, a data storage unit and a memory unit, cause the computerized system to perform a computer-implemented method for providing recommendations in connection with a brand, the method involving: collecting user events information associated with potential customers in connection with the brand in each of a plurality of media channels and storing the collected user events information in the data storage unit; measuring metrics of the brand in each of the plurality of media channels and storing the measured brand metrics in the data storage unit; collecting information on a marketing activity in connection with the brand in each of the plurality of media channels and storing the collected marketing activity information in the data storage unit; analyzing the collected user events information, the measured brand metrics and the collected marketing activity information to obtain a brand feedback information; storing the brand feedback information in the data storage unit; and providing a plurality of recommendations based on the brand feedback information.

In one or more embodiments, the plurality of channels comprise at least one channel selected from a group of web, blogs, social networks, search engines, contextual ad networks, and email campaigns.

In one or more embodiments, the data storage unit further stores a user events aggregation module for aggregating the collected user events information and storing the aggregated user events information in a database system.

In one or more embodiments, the data storage unit further stores a measured brand metrics aggregation module for aggregating the measured brand metrics and storing the aggregated measured brand metrics in a database system.

In one or more embodiments, the data storage unit further stores a marketing activity information aggregation module for aggregating the collected marketing activity information and storing the aggregated marketing activity information in a database system.

In one or more embodiments, the method further involves receiving information on the plurality of media channels.

In one or more embodiments, the plurality of recommendations comprise an ordered list of marketing actions associated with the plurality of media channels.

In one or more embodiments, the method further involves sorting the ordered list of marketing actions based on a predicted marketing effect.

In one or more embodiments, the method further involves calculating a similarity between two brands and to obtain brand similarity information.

In one or more embodiments, the method further involves accumulating marketing experience for the brand through recording subsequent snapshots of brand model parameters and calculated effect of each change of brand content associated with the brand.

In one or more embodiments, the method further involves applying the marketing experience accumulated for a first brand to a second brand based on the brand model parameters, the brand similarity information, and the calculated change effect.

In one or more embodiments, the method further involves predicting an effect of a change of a brand content based on the accumulated marketing experience and the brand similarity information.

Additional aspects related to the invention will be set forth in part in the description which follows, and in part will be obvious from the description, or may be learned by practice of the invention. Aspects of the invention may be realized and attained by means of the elements and combinations of various elements and aspects particularly pointed out in the following detailed description and the appended claims.

It is to be understood that both the foregoing and the following descriptions are exemplary and explanatory only and are not intended to limit the claimed invention or application thereof in any manner whatsoever.

### BRIEF DESCRIPTION OF THE DRAWINGS

The accompanying drawings, which are incorporated in and constitute a part of this specification exemplify the embodiments of the present invention and, together with the description, serve to explain and illustrate principles of the inventive technique. Specifically:

FIG. 1 illustrates an embodiment of logical structure suitable for providing recommendations to marketers for purpose of increasing the exposure of the Brand through available media channels.

FIG. 2 illustrates the use case scenario of the Recommender System as a standalone web service.

FIG. 3 illustrates the use case scenario of the Recommender System as a component of the marketing solution.

FIG. 4 illustrates an embodiment of process for registering the brand in the Recommender System.

FIG. 5 illustrates an embodiment of the Recommender System data flow aspect.

FIG. 6 illustrates an embodiment of the Recommendation Effect Estimation Sub-System data flow aspect.

FIG. 7 illustrates an embodiment of process for generating recommendations based on the estimated recommendation effect.

FIG. 8 illustrates an embodiment of the Brand Media Channel Traffic Model.

FIG. 9 illustrates examples of models of the Recommendation Effect over time.

FIG. 10 illustrates an embodiment of process for constructing the Channel Snapshot suitable for analysis and effect estimation.

FIG. 11 illustrates an embodiment of process for estimating the effect of recommendations for target Brand.

FIG. 12 illustrates an embodiment of process for computing similarity for two Brands.

FIG. 13 illustrates an embodiment of hardware for implementing the Recommender System.

### DETAILED DESCRIPTION

In the following detailed description, reference is made to the accompanying drawing(s), in which identical functional elements are designated with like numerals. The aforementioned accompanying drawings show by way of illustration, and not by way of limitation, specific embodiments and implementations consistent with principles of the present invention. These implementations are described in sufficient detail to enable those skilled in the art to practice the invention, and it is to be understood that other implementations may be utilized and that structural changes and/or substitutions of various elements may be made without departing from the scope and spirit of present invention. The following detailed description is, therefore, not to be construed in a limited sense. Additionally, the various embodiments of the invention as described may be implemented in the form of software running on a general purpose computer, in the form of a specialized hardware, or combination of software and hardware.

In accordance with one aspect of the embodiments described herein, there is provided a recommender system for facilitating various marketing activities, which will be described below in detail with reference to the attached drawings.

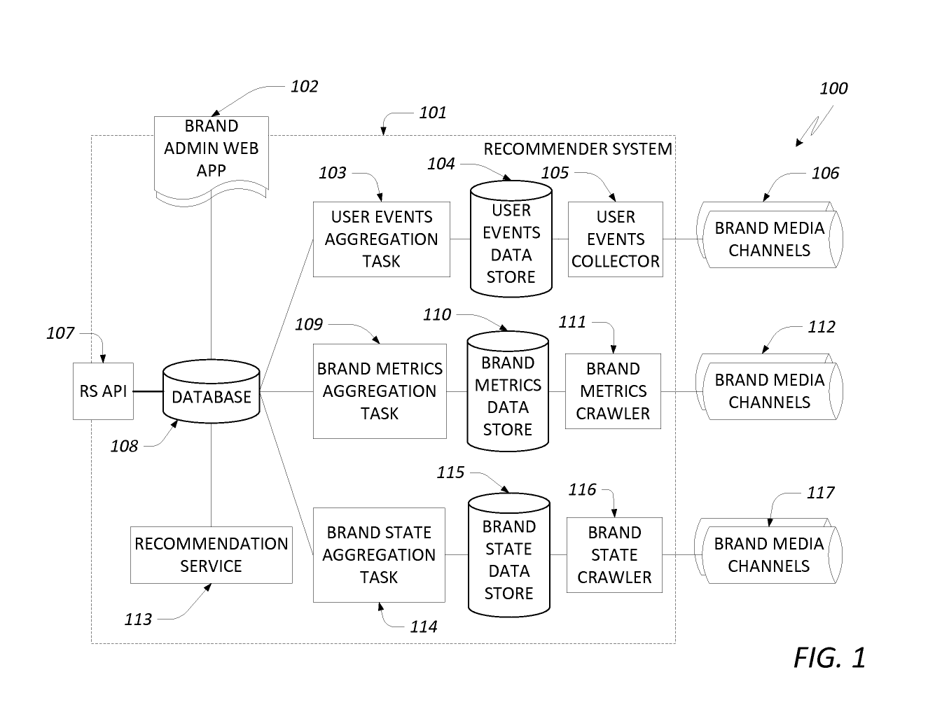

FIG. 1 illustrates an embodiment of logical structure 100 of a recommender system configured to generate marketing recommendations. The logical structure 100 describes a Recommender System 101. The Recommender System 101 gets setup information about the observable media channels 106, 112, and 117 either through Brand Admin Web App 102 or programming API 107. The Recommender System 101 holds corresponding data structures in its database storage 108.

In one or more embodiments, a Brand Metrics Crawler 111 is responsible for measuring the brand metrics for each channel 112 and storing the data in Brand Metrics Data Store 110. The Brand Metrics may include information describing Channel State, fully or partially. They may include, but not limited to, website meta-information, page layouts, references, social account state, video channel keywords, and more. Brand Metrics Aggregation Task 109 aggregates the data and stores the data in the database 108. Aggregated data produced by the aggregation task 109 is used for reporting by the Brand Admin Web application 102 as well as by the Recommendation Service 113.

In one or more embodiments, a Brand State Crawler 116 is responsible for collecting information related to the marketing activity in each channel through scanning Brand Media Channels 117. The detected marketing activities (changes to Brand State) are stored in the Brand State Data Store 115. The Brand State may include any information describing the marketing activity implemented by the Brand Marketer within media channels registered with the Recommender System 101. The Brand State may include, but not limited to, social channel content changes, posts, video channel uploads, and so on. For reporting and processing purpose the Brand State data is aggregated and placed into the database 108 by the aggregation task 114.

In one or more embodiments, a User Events collector 105 registers events caused by Potential Customers which occur in Brand Media Channels 106. User Events include clicks, page loads, scrolling events, and more. User Events are stored in the User Events Data Store 104. User Events are further aggregated by the aggregation task 103 and are stored in the database 108.

In one or more embodiments, a recommendation service 113 is responsible for processing the aggregated channel feedback in Recommender System database 108 and for generating output recommendations. The Recommendation Service may use multiple recommendation effect models, optimization and personalization modules as needed.

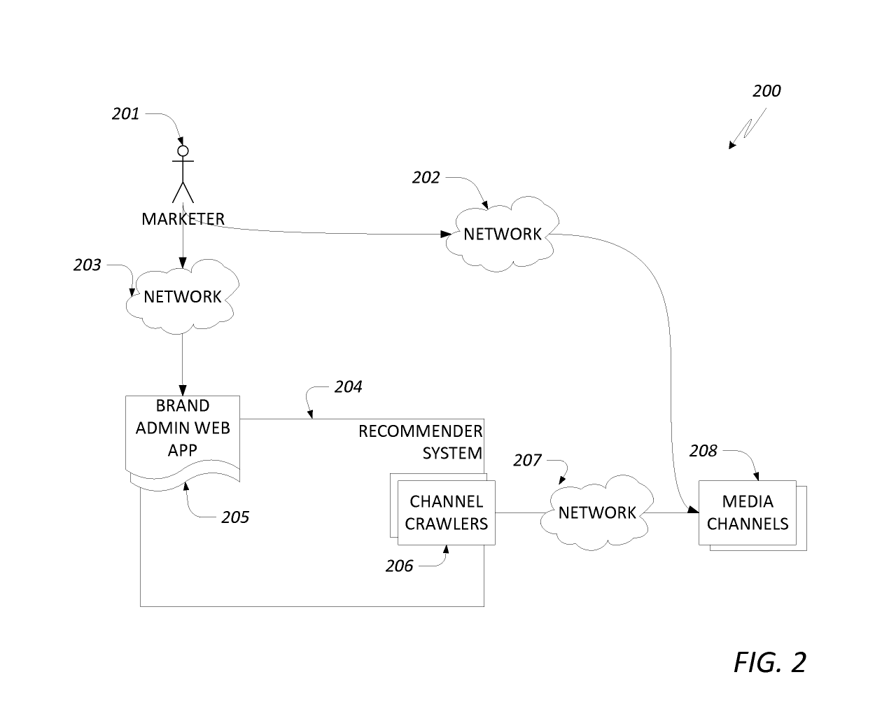

FIG. 2 illustrates the use case scenario of the Recommender System as a standalone application. As described in the diagram 200, the Recommender System 204 exposes the public interface through Brand Administrator Web Application 205.

In one or more embodiments, a Marketer 201 accesses the Brand Administrator Web Application 205 via the Network 203 to register the Brand and to set up the Media Channels 208, which the Marketer 201 accesses via Network 202. The Marketer 201 may use information from the Recommender System 204, specifically obtained by the Channel Crawlers 206 accessing the Media Channels 208 via Network 207, in order to set up the Media Channels 208. After setting up the Recommender System 204 and the Media Channels 208, the Recommender System 204 starts generating recommendations which become available to the Marketer user 201 through the Brand Admin Web App 205.

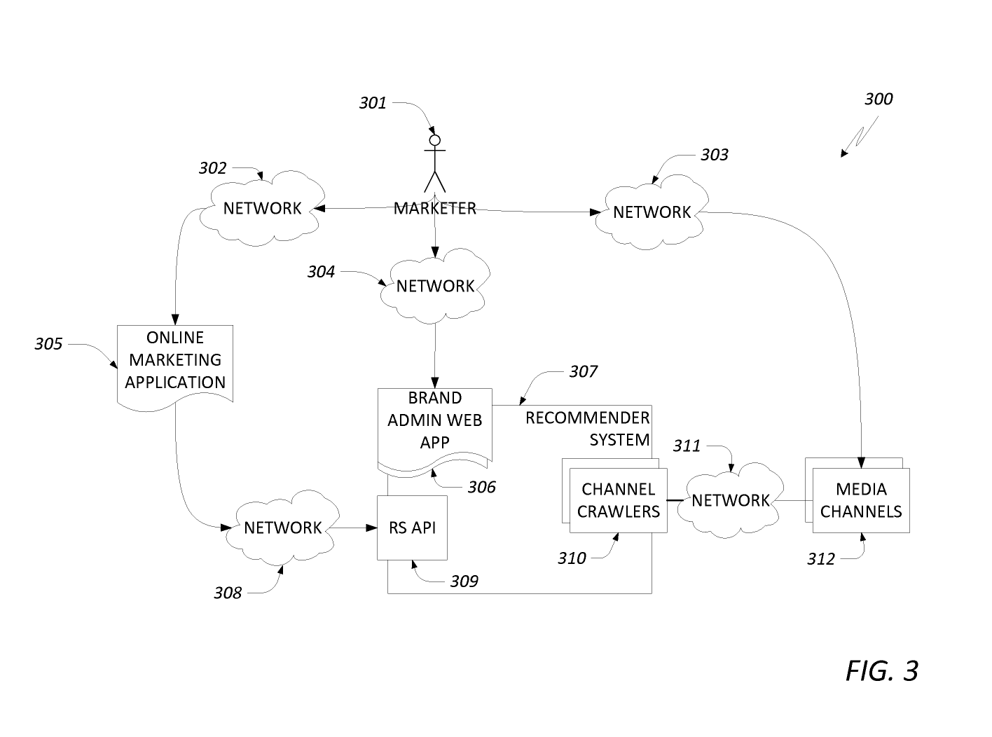

FIG. 3 illustrates the use case scenario of the Recommender System 307 as the component of an online marketing platform. Part of the diagram 300 describes a process similar to the use case described in the diagram 200. The Marketer 301 accesses the Brand Administrator Web Application 306 via Network 304. The Marketer 301 sets up the Media Channels 312, which the Marketer 301 accesses via Network 303. The Marketer 301 may use the information from the Channel Crawlers 310 component of the Recommender System 307, which access Media Channels 312 via Network 311. In contrast to diagram 200, in the use case depicted in diagram 300 the Online Marketing Application 305 is connected directly to the Recommender System 307. The Recommender System 307 exposes a public API 309 for Online Marketing Applications 305 to consume via Network 308. The recommendations generated by the Recommender System 307 are extracted by the Online Marketing Application 305 and are presented to the Marketer 301 who accesses the Online Marketing Application 305 via Network 302.

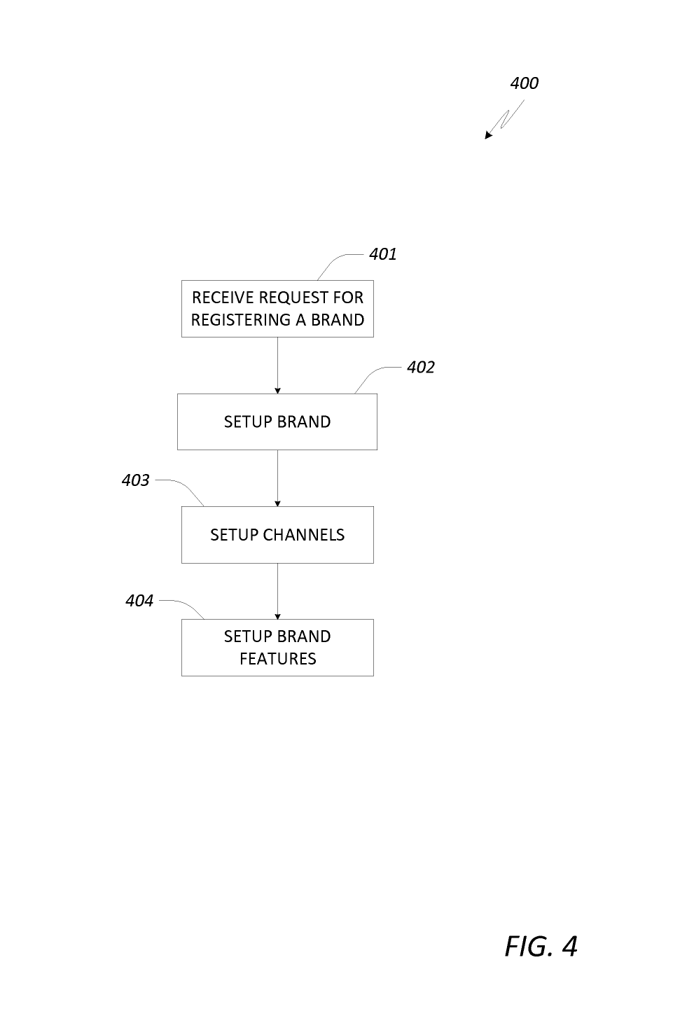

FIG. 4 illustrates an embodiment of process for registering the brand in the online marketing system providing recommendations for increasing traffic of target media channels 400. The process is activating upon reception of a Request for Registering a Brand 401. Subsequently during the step 402 the process of Brand Setup is performed, during which a series of the information describing the Brand is entered into the Database. Upon completion of the step 402, the Channel Setup Process 403 is started. The Media Channels that can be enabled during the Channel Setup Process 403 include, but are not limited to Website, Blog, Social Networks, Online Ad Networks, Email Campaigns, and other promotional campaigns. There is no limit on number of Media Channels used by the system. The features of selected Media Channels are configured during the Brand Feature Setup Process 404. Setting up Brand Features is necessary for calculations of the Brand Similarity. Brand Features include parameters such as Brand Taxonomy, target audience demographics, geography, and more.

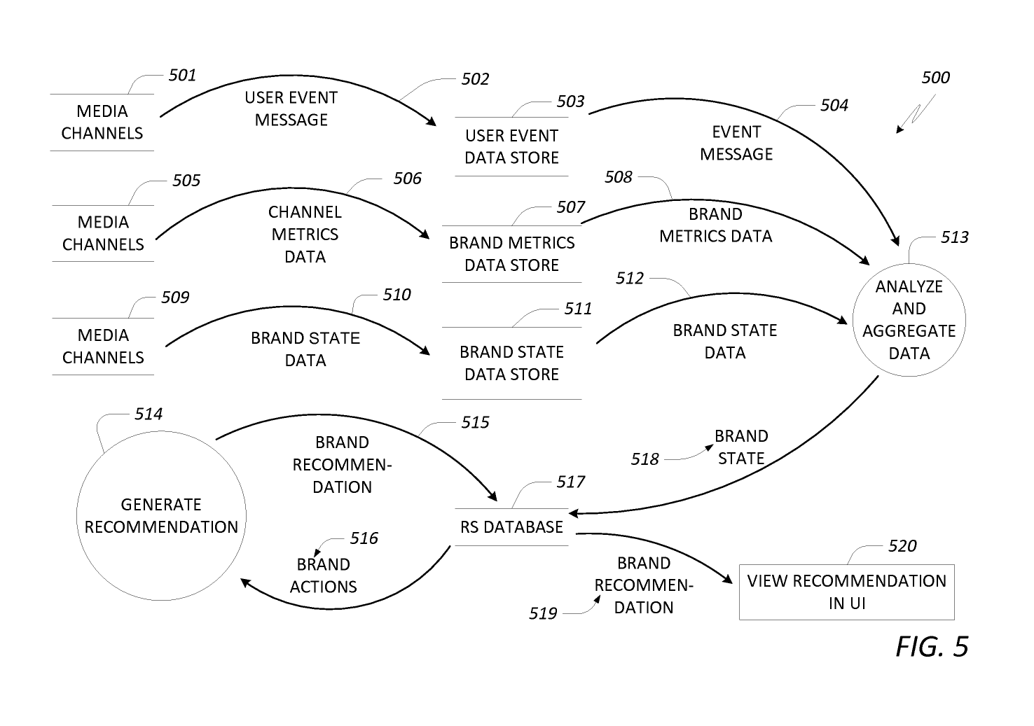

FIG. 5 illustrates an embodiment of the recommender system in data flow aspect. The Media Channels 501, 505, 509 serve as the sources of three types of data used in the recommendation generation and analysis: User Event Messages 502, Channel Metrics Data 506, and Brand State Data 510. User Event Message data 502 is stored in the User Event Data Store 503. Channel Metrics Data 506 is stored in the Brand Metrics Data Store 507. Brand State Data 510 is stored in the Brand State Data Store 511, All data 504, 508, 512 is passed from the respective Data Stores 503, 507, 511 for aggregation by the Analysis and Data Aggregation process 513. The result of the work of the Analysis and Data Aggregation process is the Brand State 518, which is stored in the Recommender System Database 517.

In one or more embodiments, a Recommendation Generation process 514 iterates over all possible Brand Actions 516 and based on the Brand State 518 stored in the Recommender System Database 517 produces Brand Recommendations 515, which are passed to and stored in the Recommender System Database 517. The Recommender System User Interface (UI) for Viewing Recommendations 520 accesses the Recommender System Database 517, and extracts from it the Brand Recommendations 519 which it then displays.

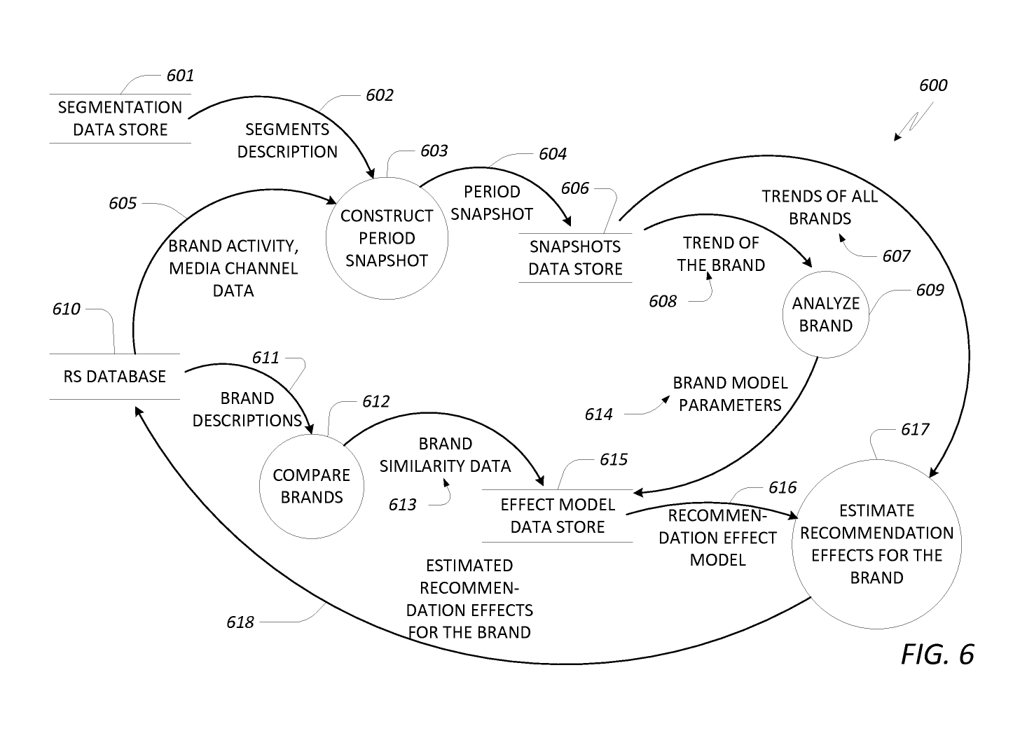

FIG. 6 illustrates an embodiment, in more detail, of the information exchange between the Recommender System Database 517 and the Recommendation Generation process 514 from FIG. 5. In FIG. 6, the Recommender System Database 610 provides several services for the Recommendation Estimation Process 617, and, in turn, receives Estimated Recommendation Effects Data for the Brand 618 from the Recommendation Estimation Process 617.

In one or more embodiments, an information about the Brand State and the resulting effect (expressed as the media channel traffic) is aggregated by the Period Snapshot Construction process 603, producing the Traffic Period Snapshots 604, stored in the Brand Snapshots Data Store 606. From the Traffic Period Snapshots, Brand Trends for a given Brand 608 are constructed. Additionally, the Period Snapshot Construction process 603 extracts the Brand Activity on Media Channels data 605 from the Recommender System database 610 using the traffic segments description 602 obtained from the segmentation data store 601.

In one or more embodiments, all brand snapshots are stored in the Brand Snapshots Data Store 606 grouped by brand trends. The Trends of each brand 608 are analyzed by the Brand Analysis process 609 in order to obtain the Brand Model Parameters 614. Brand Model Parameters 614 are the characteristics of the Brand, determining its perception by the Effect Model. It allows the Recommender System to use the marketing experience of one Brand in preparing recommendations for other Brands, possibly with different Brand Model Parameters.

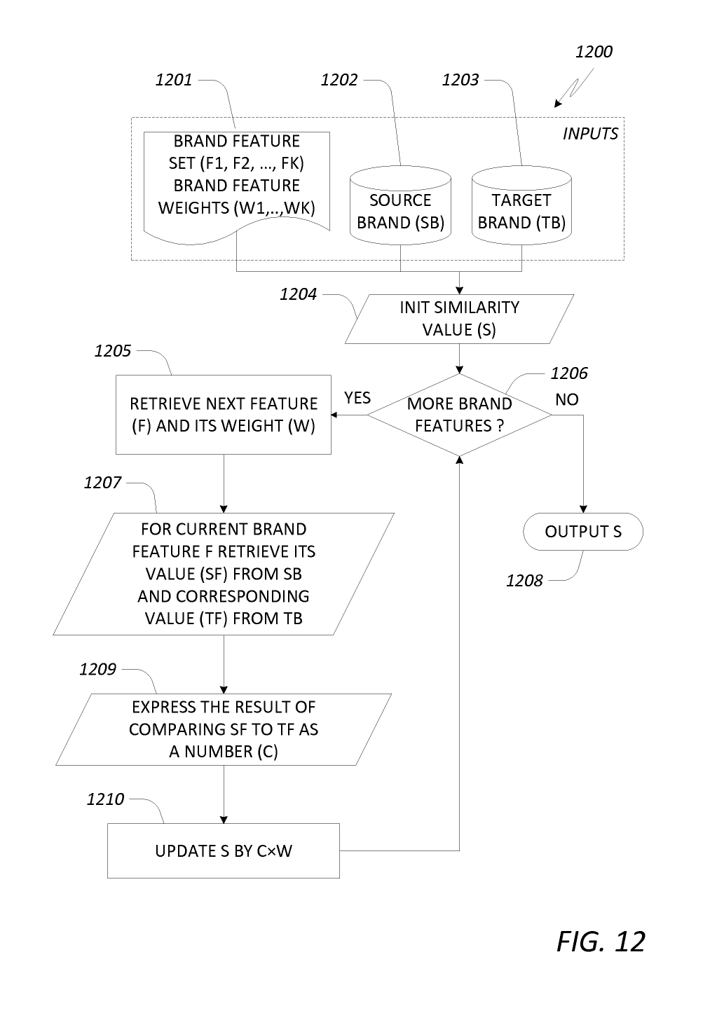

In one or more embodiments, in parallel to establishing the Brand Model Parameters 614 for each Brand, a second sub-process does the pair wise similarity comparisons for Brands. The Brand Comparison process 612 uses the Brand Descriptions 611 stored in the Recommender System Database 610 to produce Brand Similarity Data (Brand Similarity Scores) 613 for each pair of Brands. (see FIG. 12 for an embodiment of the Brand Comparison process 612 in more detail). The Brand Similarity data 613 and the Brand Model Parameters data 614 are used to tune the Recommendation Effect Model 616 and stored in the Recommendations Effects Model Store 615. The Recommendation Estimation Process 617 receives the Recommendation Effects Model 616 tuned for a specific Brand based on the Brand Model Parameters 614 and the Brand Similarity data 613 comparing the Brand to all other Brands. Additionally, the Recommendation Estimation Process receives from the Period Snapshots Data Store 606 information about the Trends of all Brands in the system 607. The resulting Estimated Effect information of a Brand Action on the Brand 618 may be computed on demand and transferred to the user, but the most effective implementation stores the results first in the Recommender System Database 610.

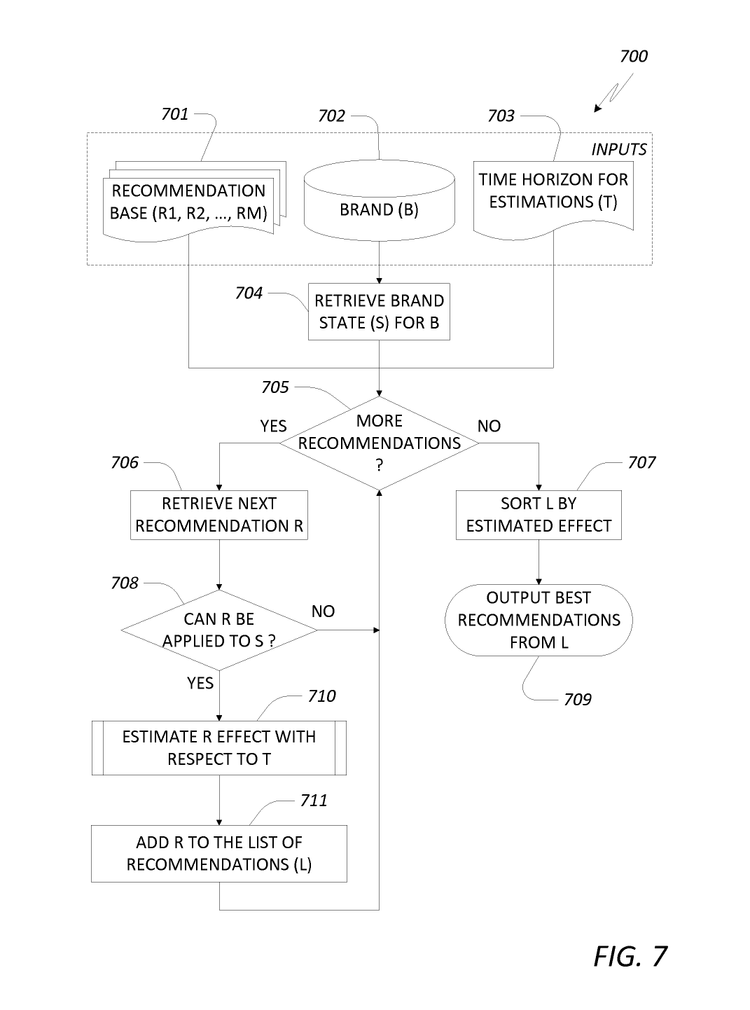

FIG. 7 illustrates an embodiment of process for generating recommendations 700 for the Brand 702 based on the estimated recommendation effect. The process 700 begins with the Retrieval of the Aggregated Brand State 704 for Brand 702. A cyclic process 705 of retrieving, one by one, of all possible recommendations from the Recommendation Base 701 and computing their effects on the current Brand State. During every iteration of the cyclic process 705, the next recommendation from the Recommendation Base 701 is retrieved by the Recommendation Retrieval process 706. Once the Recommendation Retrieval Process 706 retrieves the next recommendation R from the Recommendation Base 701, an applicability test 708 of the Recommendation R to the current state of S (constructed by the Retrieval of the Aggregated Brand State process 704) of the Brand 702. This process may access any part of the complex brand state to check the conditions of applying the recommendation. This process discovers all the parts of the brand state, where the recommendation is applicable. If the recommendation is not applicable at all, it is skipped.

In one or more embodiments, if the Recommendation R is not applicable to the State S of the Brand, the cyclic process 705 proceeds to retrieve the next recommendation from the Recommendation Base 701.

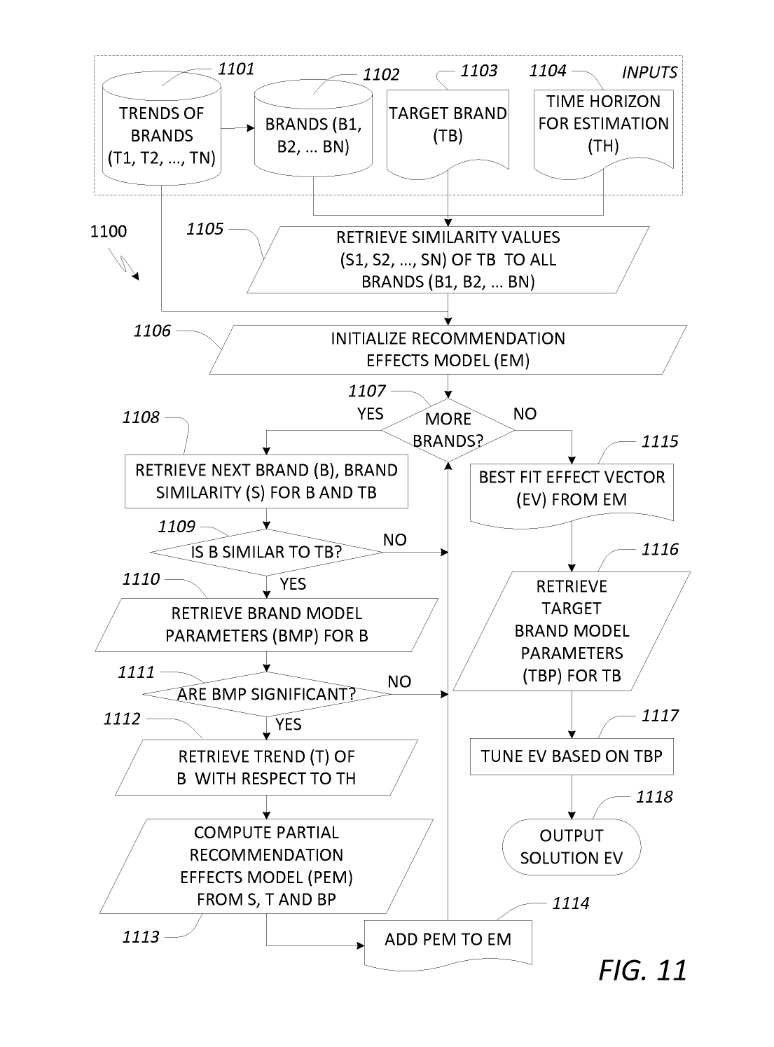

In one or more embodiments, if the Recommendation R is applicable to the State S of the Brand, the Effect Estimation process 710 is run. This process may use the time horizon 703 to skip possible old data in the brand trends (see FIG. 11 for an embodiment of the Effect Estimation process 710 in detail).

In one or more embodiments, once the Effect Estimation process 710 produces estimated effects of applying the Recommendation R to the Brand 702 in its State S, this information is added to the Recommendation List, but Recommendation List Construction process 711. This process is responsible for generating the final recommendation and it generates a recommendation for every applicable case within the Brand. All recommendations are finally added into the list.

In one or more embodiments, when, the cyclic process 705 exhausts all recommendations from the Recommendation Base 701, the final part of the process 700 begins. The Recommendation List built by the Recommendation List Construction process 711 is sorted by the estimated effect by the Recommendation List Sorter process 707. The Output Recommendations process 709 outputs top recommendations from the sorted Recommendation List. The number of output recommendations may be limited for usability reasons.

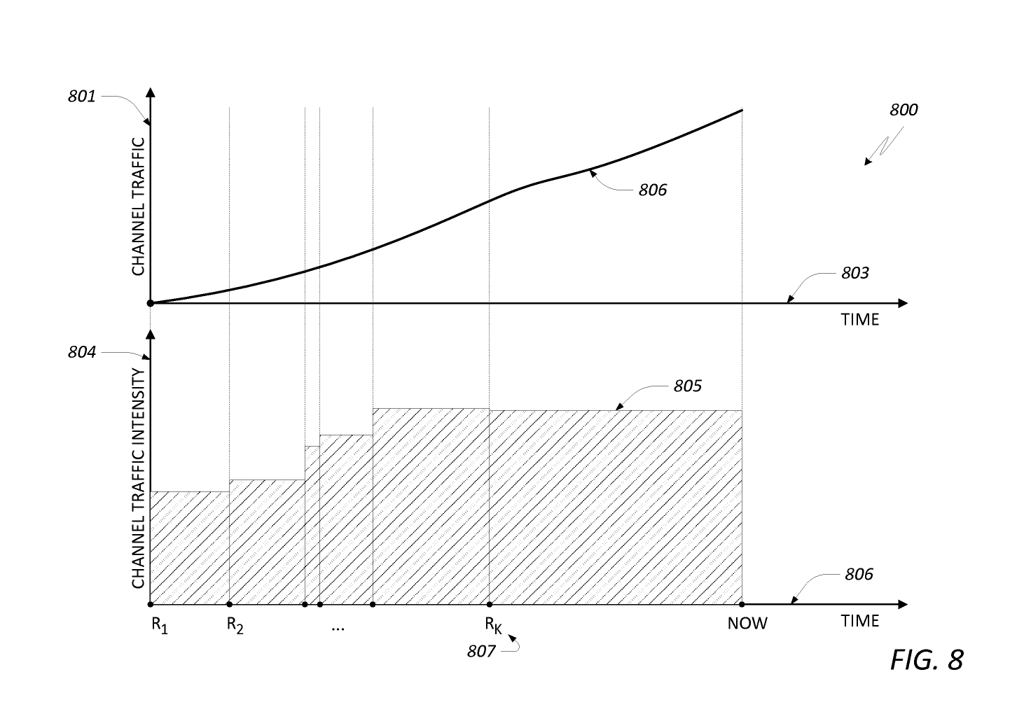

FIG. 8 illustrates an embodiment of the Brands Media Channel Traffic Model 800, used within the channel snapshotting process and within the channel trend registration process. The particular embodiment of the model is represented by means of two plots. Both graphs share the horizontal coordinate axis 803 and 806 representing Time. Time=0, in both cases is the time when the Brand started its presence on a specific Media Channel. The first graph depicts a possible curve of the Media Channel of the Brand in absolute values. The vertical axis for this graph 802 measures the absolute amount of Channel Traffic. The Channel Traffic curve 806 measures the total cumulative amount of Channel Traffic experienced by the Brand Media Channel at each moment of time. It must be a non-decreasing curve, but may have any other shape. The second plot of channel traffic measures Channel Traffic Intensity 804. It is shown in the model 800 with the time axis 806 set synchronous with the time axis 803 of the Cumulative Channel Traffic plot (803,801,806). The traffic of the channel is usually measured at some registration moments R [symbol] 1, . . . Rk 807. The last registration moment usually matches the current time (shown on the figure), but it is not necessary. At some moments the channel has applied some recommendations, but these moments do not necessarily match the registration moments 807. The registration moments divide all the channel observation time into several intervals. The bar chart 805 shows the channel traffic intensity, i.e., Channel Traffic per Unit of Time, for each time interval. Each channel traffic interval is represented by the corresponding snapshot. The set of the snapshots represents entire media channel trend or brand trend.

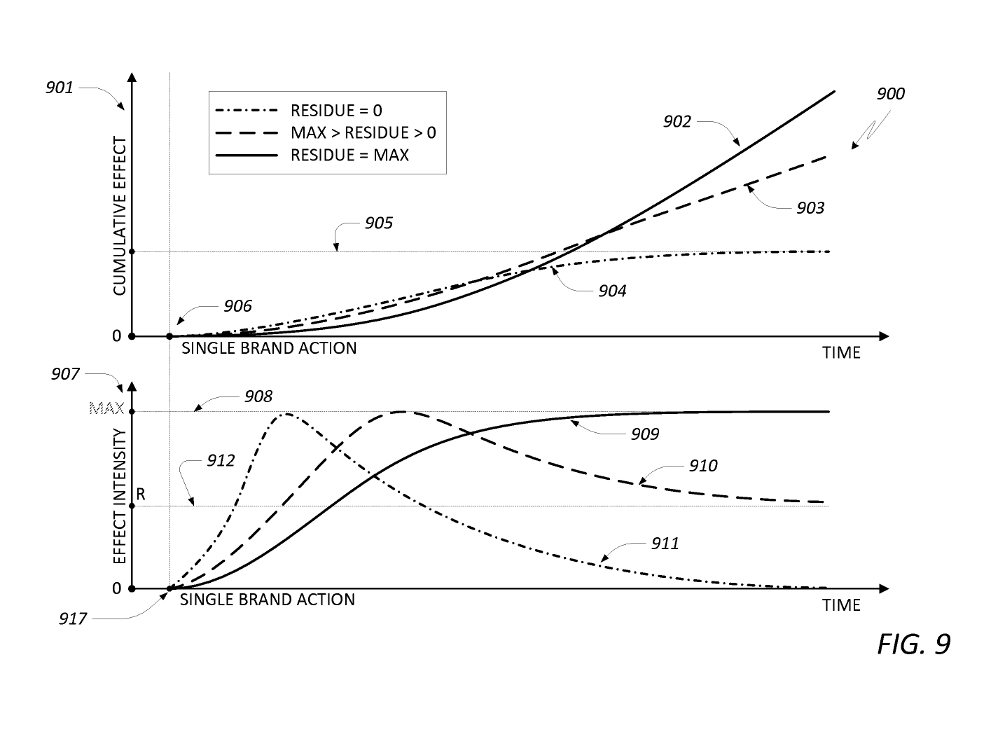

FIG. 9 illustrates the embodiments of some examples of the recommendation effect functions suitable for building recommendation effect models as disclosed in this invention. The effect template function may be set in two forms—in the cumulative form 901 or in the form of the effect intensity 907. For each effect template function specified in the cumulative effect form, there exists an exact representation of this function in the effect intensity form, and vice versa. This is illustrated in the plots 901 and 902 using the pairs of functions with the same line structure used for depiction. As such, the curve 902 and the curve 909 represent the same recommendation effect function described in the cumulative effect and effect intensity forms respectively. The curve 904 and the curve 911 describe the same recommendation effect function in the cumulative effect and effect intensity forms respectively. The curves 903 and 910 describe the same recommendation effect function in the cumulative effect and effect intensity forms respectively.

In one or more embodiments, the recommendation effect template function is the model of the average expected channel traffic change in response to a use of a single specific recommendation on this channel. That is why chart 900 is organized the same way as the channel traffic model 800. Time axes of booth plots 901 and 907 are synchronous. Time points 906 and 913 are the moments when the recommendation was implemented on the channel.

Chart 900 contains examples of three different recommendation effect templates. The solid curves 909 and 902 are typical for some effect which reaches the maximum 908 of channel traffic intensity and never fades. The example of corresponding recommendation may be adding keywords to the web page for search engine optimization. The dash-dotted curves 904 and 911 are typical for some effect which rapidly fades after it reaches its maximum 908 (depicted here to be the same as the maximum of the curve 909 for illustrative purposes only. Typically, each curve will have its own maximum traffic intensity that is not correlated with the maximum traffic intensity reachable by other recommendation effect curves) until the complete disappearance of traffic attributed as the effect of this recommendation. The example of corresponding recommendation may be posting a Twitter message. The cumulative effect of such recommendation is limited to some finite value 905. The dashed curves 910 and 903 are typical of some in-between behavior, which has a non-zero 912 residual effect of the recommendation, i.e., which represents a situation where, upon reaching the maximum traffic intensity 908 the traffic intensity decreases until it reaches a stable value 912, which is referred in this document as the residual traffic intensity of a recommendation. Adding the new article to the blog may be an example of such recommendation. The effect templates depicted in chart 900 may take different times to reach their maximum and their stable (for curves 911 and 910) values. Such variations are not depicted. Other shapes of the effect templates (not shown) are also possible, for example, to model some dynamic or cyclic behaviors, such as seasonal effects.

In one or more embodiments, the suitable ways of building the recommendation effect model from template functions may include, but are not limited to scaling, time-shifting, time-stretching, value offset, and its combination with other templates. The embodiments of specific recommendation effect models may be described by a set of parameters. Examples of such parameters may include the value of the residual traffic, the time to reach peak effect intensity, the value of the peak effect intensity. Other effect model templates can be described using parameters not mentioned here. The parameters mentioned above are given for illustrative purposes only and do not construe an exhaustive list.

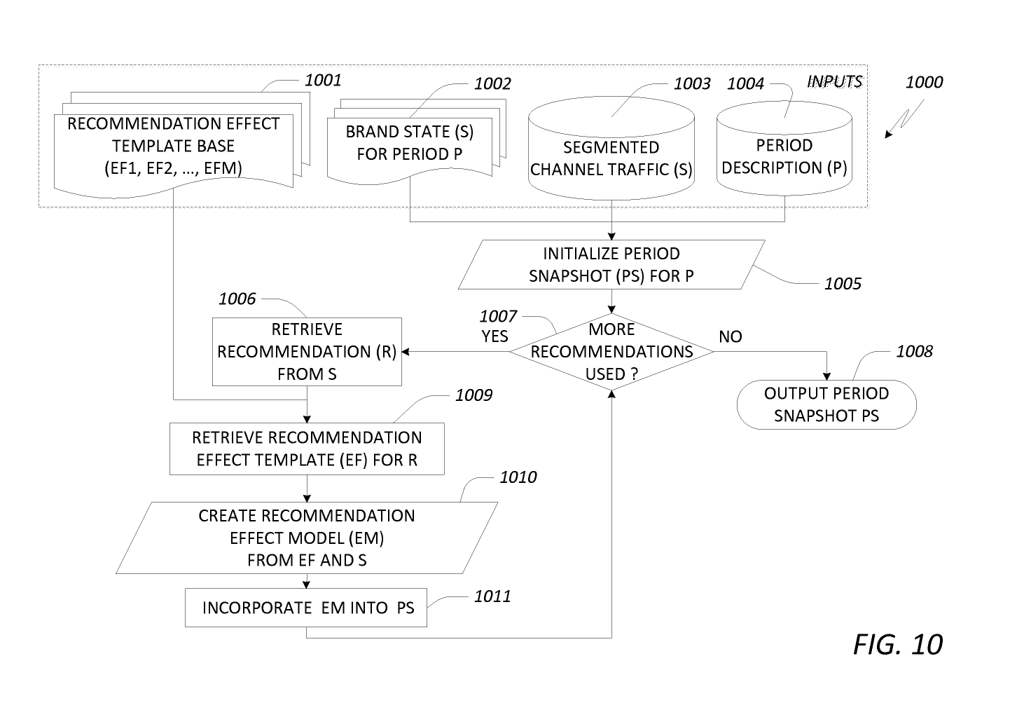

FIG. 10 illustrates an embodiment of process for constructing a channel snapshot suitable for analysis and estimation of the recommendation effect. The resulting snapshot aggregates the Segmented Channel Traffic Data 1003 and the Brand State 1002 for the Given Period 1004.

In one or more embodiments, the process of this aggregation begins with the Snapshot Initialization 1005. The Snapshot Initialization aggregates the channel traffic in the snapshot for the period 1004. The Snapshot Initialization 1005 adds no information about recommendation effects, used in the period. At the end of the Snapshot Initialization 1005, the snapshot PS is set to a state, where all the channel traffic of the given period is modeled as the result of some default channel actions, but not as a result of using recommendations. The main part of the Period Snapshot Estimation process 1000 occurs within the cyclic process 1007 which iterates over a list of all recommendation actions taken by the Brand and contained in the Brand State 1002. For as long as additional recommendations need to be processed, the Recommendation Retrieval process 1006 retrieves the next unprocessed recommendation R from the Brand State S 1002. On the next step, the Recommendation Effect Template Retrieval Process 1009 retrieves the recommendation effect template EF for R from the Recommendation Effect Template Base 1001 (see FIG. 9 for more information on the structure of the recommendation effect templates). The Recommendation Effect Template Base 1001 stores a collection of recommendation effect templates for each recommendation available to the Recommender System. Using the recommendation effect template EF and Brand State S 1002, the Recommendation Effect Model Creation process 1010 produces the effect model for the recommendation R. The produced effect model is incorporated into the Period Snapshot model by the Effect Model Incorporation process 1011. Upon consideration of all recommendations, at the Output Phase 1008, the Period Snapshot is set to state, where all the channel traffic for the given period is expressed as the result of the application of observed recommendations.

In one or more embodiments, the period snapshot has a formal expression. The suitable form of the expression matches the following criteria: the snapshot, combined with some effect estimations for all recommendations, brand model parameters estimation and the estimated default effect of the channel determines the difference between the actual channel traffic and the expected channel traffic for the period of the snapshot.

FIG. 11 illustrates an embodiment of the process 1100 for estimating the effects of all recommendations for the target Brand 1103. This process allows effect estimation even for Brands with short observation period or inaccurately collected Brand State. The process 1100 overcomes pointed issues through sharing the experience of other Brands 1102 with the target Brand 1103. The experience of other Brands is provided via Brand Trends 1101.

In one or more embodiments, the process 1100 includes three phases: data preparation 1105, 1106, implementation of effects model 1107, 1108, 1109, 1110, 1111, 1112, 1113, 1114, and fitting the data into the model 1115, 1116, 1117.

In one or more embodiments, the preparation phase starts the Brand Similarity Values Retrieval process 1105 in which Brand similarity values are retrieved for the target brand 1103 for all brands 1102. Following that, Recommendation Effects Model Initialization 1106 takes place, in which the recommendation effects model is initialized. This model includes all recommendation effects, included in the Brand Trends.

In one or more embodiments, the model implementation phase is controlled by the cyclic process 1107, which iterates over the list of Brands 1102. The Brand Retrieval Process 1108 retrieves the next Brand Bi to be considered and the similarity value Si=similarity (TB, Bi): the similarity between the Target Brand TB 1103 and the retrieved Brand Bi. Only Brands sufficiently similar to the Target Brand participate in the effects model. The Similarity Score Filter 1109 filters out all non-similar brands. On the next step, the Brand Model Parameters Retrieval process 1110 retrieves the Brand Model Parameters BP for the Brand Bi. The Parameters Filter 1111 identifies brands with Model Parameters that are sufficiently high and influential for the later calculations. The two Filters 1109 and 1111 increase the performance and stability of the process 1100.

In one or more embodiments, Brands that pass the Filters 1109 and 1111 are called suitable. For each suitable Brand the Trend Retrieval process 1112 retrieves its trends. The Time Horizon 1104 is used as the time-filtering criteria. Time filtering process is subject to customization.

In one or more embodiments, the Partial Recommendation Construction process 1113 computes the effects model from the Brand Trend and Brand Model Parameters. The suitable partial model matches the following criteria: the partial model combined with some effect estimations (for all recommendations) determines the difference between the actual channel traffic and the expected channel traffic for all periods of the brand trend (and thus all periods of the model).

In one or more embodiments, the recommendations effects model created by the Partial Recommendation Construction process 1113 is called partial because in most cases this model is not able to unambiguously determine the desired optimal effects. To prevent ambiguity of the solution, all different partial models are incorporated in the overall recommendation effects model by the Recommendation Model Construction process 1114. This process is allowed to use additional heuristics and processes to optimize the recommendation effects model.

In one or more embodiments, the model fit phase of the process 1100 starts when the cyclic process 1107 completes, i.e., when all Brands have been considered by the cycle 1107, 1108, 1109, 1110, 1111, 1112, 1113, 1114. The Recommendation Effects Model EM computed on the final iteration of the Recommendation Model Construction process 1114 is passed to the Best Fit Effect Vector Construction process 1115. The Best Fit Effect Vector Construction process 1115 computes the recommendation effects vector with best fit for all the conditions of the constructed model. Embodiments of some implementations (not depicted) may allow the Best Fit Effect Vector Constructions process 1115 to gracefully fail if the model is badly conditioned. The embodiment depicted in the process 1100 makes the Best Fit Effect Vector Construction process 1115 a process that always returns a result. The best fit effect vector EV computed by the Best Fit Effect Vector Construction process 1115 is transformed by the Effect Vector tuning process 1117 which is immediately preceded by the Target Brand Model Parameters retrieval process 1116 which retrieves the Brand Model Parameters for the Target Brand. The tuned effect vector produced by the Effect Vector tuning process 1117 is then passed to the Output process 1118, which outputs the vector.

FIG. 12 illustrates an embodiment of process for computing similarity between a pair of Brands: the Source Brand 1202 and the Target Brand 1203. The comparison process uses the Brand Feature Set 1201 which describes every brand. The Brand Feature Set 1201 may include, but is not limited to, Brand Taxonomy, brand keywords, brand geographical location, brand target marketing segment, brand channels structure. Given a Brand, every Brand Feature from the Brand Feature Set 1201 for the Brand is represented by a numeric value. Additionally, an importance of each Brand feature is specified by a Brand Feature Weight, which is a non-negative numeric value. The Brand Similarity computation 1200 starts with the Similarity Value Initialization 1204. The computation 1200 is driven by the cyclic process 1206 which iterates over the list of brand features from the Brand Feature Set 1201. Each Brand feature and its weight from the Brand Feature Set 1201 are retrieved in turn by the Feature Retrieval process 1205. For every retrieved feature the values of the feature for the Source Brand 1202 and the Target Brand 1203 are retrieved by the Feature Retrieval process 1207. The Comparison process 1209 compares the feature values, and the Similarity Score Update process 1210 updates the similarity score by the similarity between the Source Brand 1202 and the Target Brand 1203 with respect to the currently considered feature, computed by the Comparison process 1209 multiplied by the weight W for the current Brand Feature. Upon consideration of all features from the Brand Feature Set 1201 by the cycle 1206, 1205, 1207, 1209, 1210, the final value of the similarity score, computed on the last iteration of the Similarity Score Update process 1210 is output by the Output component 1208.

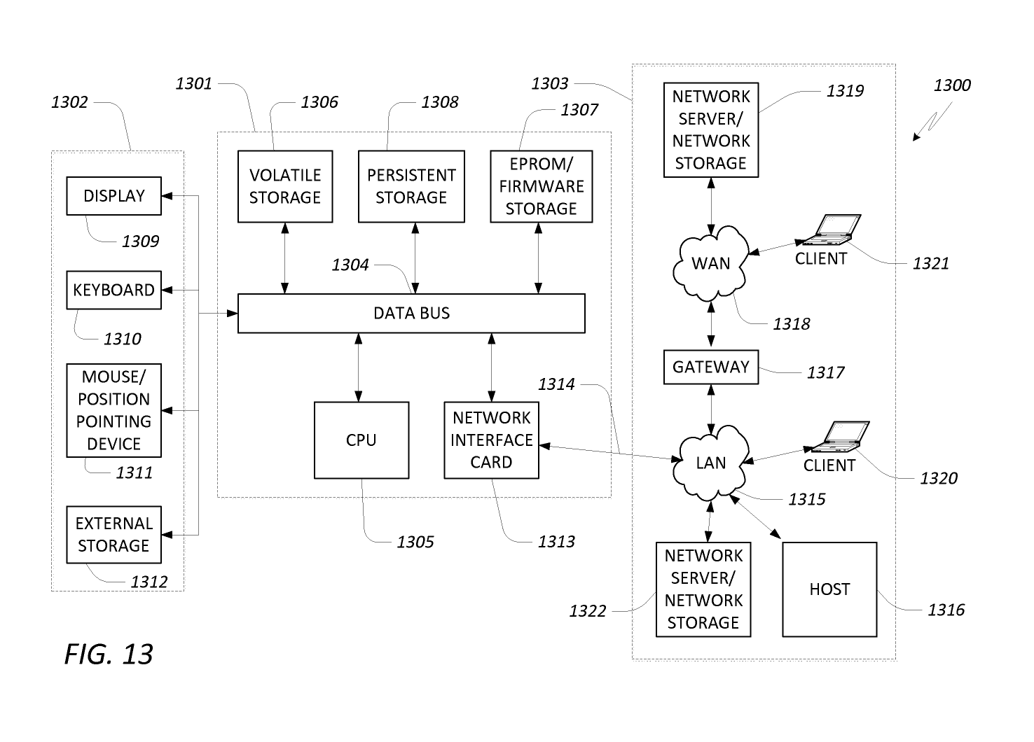

FIG. 13 illustrates an exemplary embodiment of a computer platform upon which the inventive system may be implemented. Specifically, FIG. 13 represents a block diagram that illustrates an embodiment of a computer/server system 1300 upon which an embodiment of the inventive methodology may be implemented. The system 1300 includes a computer/server platform 1301, peripheral devices 1302 and network resources 1303.

In one or more embodiments, the computer platform 1301 may include a data bus 1304 or other communication mechanism for communicating information across and among various parts of the computer platform 1301, and a processor 1305 coupled with bus 1304 for processing information and performing other computational and control tasks. Computer platform 1301 also includes a volatile storage 1306, such as a random access memory (RAM) or other dynamic storage device, coupled to bus 1304 for storing various information as well as instructions to be executed by processor 1305. The volatile storage 1306 also may be used for storing temporary variables or other intermediate information during execution of instructions by processor 1305. Computer platform 1301 may further include a read only memory (ROM or EPROM) 1307 or other static storage device coupled to bus 1304 for storing static information and instructions for processor 1305, such as basic input-output system (BIOS), as well as various system configuration parameters. A persistent storage device 1308, such as a magnetic disk, optical disk, or solid-state flash memory device is provided and coupled to bus 1304 for storing information and instructions.

Computer platform 1301 may be coupled via bus 1304 to a display 1309, such as a cathode ray tube (CRT), plasma display, or a liquid crystal display (LCD), for displaying information to a system administrator or user of the computer platform 1301. An input device 1310, including alphanumeric and other keys, is coupled to bus 1304 for communicating information and command selections to processor 1305. Another type of user input device is cursor control device 1311, such as a mouse, a trackball, or cursor direction keys for communicating direction information and command selections to processor 1305 and for controlling cursor movement on display 1309. This input device typically has two degrees of freedom in two axes, a first axis (e.g., x) and a second axis (e.g., y), that allows the device to specify positions in a plane.

An external storage device 1312 may be coupled to the computer platform 1301 via bus 1304 to provide an extra or removable storage capacity for the computer platform 1301. In an embodiment of the computer system 1300, the external removable storage device 1312 may be used to facilitate exchange of data with other computer systems.

The invention is related to the use of computer system 1300 for implementing the techniques described herein. In an embodiment, the inventive system may reside on a machine such as computer platform 1301. According to one embodiment of the invention, the techniques described herein are performed by computer system 1300 in response to processor 1305 executing one or more sequences of one or more instructions contained in the volatile memory 1306. Such instructions may be read into volatile memory 1306 from another computer-readable medium, such as persistent storage device 1308. Execution of the sequences of instructions contained in the volatile memory 1306 causes processor 1305 to perform the process steps described herein. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to processor 1305 for execution. The computer-readable medium is just one example of a machine-readable medium, which may carry instructions for implementing any of the methods and/or techniques described herein. Such a medium may take many forms, including but not limited to, non-volatile media and volatile media. Non-volatile media includes, for example, optical or magnetic disks, such as storage device 1308. Volatile media includes dynamic memory, such as volatile storage 1306.

Common forms of computer-readable media include, for example, a floppy disk, a flexible disk, hard disk, magnetic tape, or any other magnetic medium, a CDROM, any other optical medium, punchcards, papertape, any other physical medium with patterns of holes, a RAM, a PROM, an EPROM, a FLASH-EPROM, a flash drive, a memory card, any other memory chip or cartridge, or any other medium from which a computer can read.

Various forms of computer readable media may be involved in carrying one or more sequences of one or more instructions to processor 1305 for execution. For example, the instructions may initially be carried on a magnetic disk from a remote computer. Alternatively, a remote computer can load the instructions into its dynamic memory and send the instructions over a telephone line using a modem. A modem local to computer system can receive the data on the telephone line and use an infrared transmitter to convert the data to an infra-red signal. An infra-red detector can receive the data carried in the infra-red signal and appropriate circuitry can place the data on the data bus 1304. The bus 1304 carries the data to the volatile storage 1306, from which processor 1305 retrieves and executes the instructions. The instructions received by the volatile memory 1306 may optionally be stored on persistent storage device 1308 either before or after execution by processor 1305. The instructions may also be downloaded into the computer platform 1301 via Internet using a variety of network data communication protocols well known in the art.

The computer platform 1301 also includes a communication interface, such as network interface card 1313 coupled to the data bus 1304. Communication interface 1313 provides a two-way data communication coupling to a network link 1315 that is coupled to a local network 1315. For example, communication interface 1313 may be an integrated services digital network (ISDN) card or a modem to provide a data communication connection to a corresponding type of telephone line. As another example, communication interface 1313 may be a local area network interface card (LAN NIC) to provide a data communication connection to a compatible LAN. Wireless links, such as well-known 802.11a, 802.11b, 802.11g and Bluetooth may also be used for network implementation. In any such implementation, communication interface 1313 sends and receives electrical, electromagnetic or optical signals that carry digital data streams representing various types of information.

Network link 1313 typically provides data communication through one or more networks to other network resources. For example, network link 1315 may provide a connection through local network 1315 to a host computer 1316, or a network storage/server 1317. Additionally or alternatively, the network link 1313 may connect through gateway/firewall 1317 to the wide-area or global network 1318, such as an Internet. Thus, the computer platform 1301 can access network resources located anywhere on the Internet 1318, such as a remote network storage/server 1319. On the other hand, the computer platform 1301 may also be accessed by clients located anywhere on the local area network 1315 and/or the Internet 1318. The network clients 1320 and 1321 may themselves be implemented based on the computer platform similar to the platform 1301.

Local network 1315 and the Internet 1318 both use electrical, electromagnetic or optical signals that carry digital data streams. The signals through the various networks and the signals on network link 1315 and through communication interface 1313, which carry the digital data to and from computer platform 1301, are exemplary forms of carrier waves transporting the information.

Computer platform 1301 can send messages and receive data, including program code, through the variety of network(s) including Internet 1318 and LAN 1315, network link 1315 and communication interface 1313. In the Internet example, when the system 1301 acts as a network server, it might transmit a requested code or data for an application program running on client(s) 1320 and/or 1321 through Internet 1318, gateway/firewall 1317, local area network 1315 and communication interface 1313. Similarly, it may receive code from other network resources.

The received code may be executed by processor 1305 as it is received, and/or stored in persistent or volatile storage devices 1308 and 1306, respectively, or other non-volatile storage for later execution.

It should be understood that processes and techniques described herein are not inherently related to any particular apparatus and may be implemented by any suitable combination of software components. Further, various types of general purpose software components may be used in accordance with the teachings described herein. It may also prove advantageous to extend the taxonomy as well as number of media Channels and Channel Actions to perform the method steps described herein. The present invention has been described in relation to particular examples, which are intended in all respects to be illustrative rather than restrict. Those skilled in the art will appreciate that many different combinations of software components, and software services will be suitable for practicing the present invention. For example, the described software may be implemented in a wide variety of programming or scripting languages, such as .NET, PHP, Java, etc.

Moreover, other implementations of the invention will be apparent to those skilled in the art from consideration of the specification and practice of the invention disclosed herein. Various aspects and/or components of the described embodiments may be used singly or in any combination in the computerized system and computer-implemented method for generating marketing recommendations. It is intended that the specification and examples be considered as exemplary only, with a true scope and spirit of the invention being indicated by the following claims.

What is claimed is:

1. A computerized system for providing recommendations in connection with a brand, the computerized system comprising at least one processing unit, a data storage unit and a memory unit, the at least one processing unit executing a set of computer-readable instructions comprising:
a. a user event collector module for collecting user events information associated with potential customers in connection with the brand in each of a plurality of media channels and storing the collected user events information in the data storage unit;
b. a brand metrics crawler for measuring metrics of the brand in each of the plurality of media channels and storing the measured brand metrics in the data storage unit;
c. a brand state crawler for collecting information on a marketing activity in connection with the brand in each of the plurality of media channels and storing the collected marketing activity information in the data storage unit; and
d. a recommender module for analyzing the collected user events information, the measured brand metrics and the collected marketing activity information to obtain a brand feedback information, for storing the brand feedback information in the data storage unit and for providing a plurality of recommendations based on the brand feedback information.

2. The computerized system of claim 1, wherein the plurality of channels comprise at least one channel selected from a group of web, blogs, social networks, search engines, contextual ad networks, and email campaigns.

3. The computerized system of claim 1, wherein the data storage unit further stores a user events aggregation module for aggregating the collected user events information and storing the aggregated user events information in a database system.

4. The computerized system of claim 1, wherein the data storage unit further stores a measured brand metrics aggregation module for aggregating the measured brand metrics and storing the aggregated measured brand metrics in a database system.

5. The computerized system of claim 1, wherein the data storage unit further stores a marketing activity information aggregation module for aggregating the collected marketing activity information and storing the aggregated marketing activity information in a database system.

6. The computerized system of claim 1, wherein the at least one processing unit further executes a configuration module for receiving information on the plurality of media channels.

7. The computerized system of claim 1, wherein the at least one processing unit further executes a user interface module for providing the plurality of recommendations to a user.

8. The computerized system of claim 1, wherein the plurality of recommendations comprise an ordered list of marketing actions associated with the plurality of media channels.

9. The computerized system of claim 8, wherein the recommender module is configured to sort the ordered list of marketing actions based on a predicted marketing effect.

10. The computerized system of claim 1, wherein the recommender module is configured to calculate a similarity between two brands and to obtain brand similarity information.

11. The computerized system of claim 10, wherein the recommender module is configured to accumulate marketing experience for the brand through recording subsequent snapshots of brand model parameters and calculated effect of each change of brand content associated with the brand.

12. The computerized system of claim 11, wherein the recommender module is configured to apply the marketing experience accumulated for a first brand to a second brand based on the brand model parameters, the brand similarity information, and the calculated change effect.

13. The computerized system of claim 11, wherein the recommender module is configured to predict an effect of a change of a brand content based on the accumulated marketing experience and the brand similarity information.

14. A computer-implemented method for providing recommendations in connection with a brand, the computer-implemented method being performed in connection with a computerized system comprising at least one processing unit, a data storage unit and a memory unit, the method comprising:
a. collecting user events information associated with potential customers in connection with the brand in each of a plurality of media channels and storing the collected user events information in the data storage unit;
b. measuring metrics of the brand in each of the plurality of media channels and storing the measured brand metrics in the data storage unit;
c. collecting information on a marketing activity in connection with the brand in each of the plurality of media channels and storing the collected marketing activity information in the data storage unit;
d. analyzing the collected user events information, the measured brand metrics and the collected marketing activity information to obtain a brand feedback information;
e. storing the brand feedback information in the data storage unit; and
f. providing a plurality of recommendations based on the brand feedback information.

15. The computer-implemented method of claim 14, wherein the plurality of channels comprise at least one channel selected from a group of web, blogs, social networks, search engines, contextual ad networks, and email campaigns.

16. The computer-implemented method of claim 14, wherein the data storage unit further stores a user events aggregation module for aggregating the collected user events information and storing the aggregated user events information in a database system.

17. The computer-implemented method of claim 14, wherein the data storage unit further stores a measured brand metrics aggregation module for aggregating the measured brand metrics and storing the aggregated measured brand metrics in a database system.

18. The computer-implemented method of claim 14, wherein the data storage unit further stores a marketing activity information aggregation module for aggregating the collected marketing activity information and storing the aggregated marketing activity information in a database system.

19. The computer-implemented method of claim 14, further comprising receiving information on the plurality of media channels.

20. A non-transitory computer-readable medium embodying a set of computer-executable instructions, which, when executed in connection with a computerized system comprising at least one processing unit, a data storage unit and a memory unit, cause the computerized system to perform a computer-implemented method for providing recommendations in connection with a brand, the method comprising:
a. collecting user events information associated with potential customers in connection with the brand in each of a plurality of media channels and storing the collected user events information in the data storage unit;
b. measuring metrics of the brand in each of the plurality of media channels and storing the measured brand metrics in the data storage unit;
c. collecting information on a marketing activity in connection with the brand in each of the plurality of media channels and storing the collected marketing activity information in the data storage unit;
d. analyzing the collected user events information, the measured brand metrics and the collected marketing activity information to obtain a brand feedback information;
e. storing the brand feedback information in the data storage unit; and
f. providing a plurality of recommendations based on the brand feedback information.
